(19) United States
(12) Patent Application Publication
(10) Pub. No.: US 2024/0024770 A1
(43) Pub. Date: Jan. 25, 2024

(54) SERVER DEVICE, INFORMATION PROCESSING DEVICE, AND INFORMATION PROVIDING METHOD

(71) Applicant: Sony Interactive Entertainment Inc., Tokyo (JP)

(72) Inventor: Nobuyuki Nakamura, Kanagawa (JP)

(73) Assignee: Sony Interactive Entertainment Inc., Tokyo (JP)

(21) Appl. No.: 18/350,998

(22) Filed: Jul. 12, 2023

(30) Foreign Application Priority Data
Jul. 20, 2022 (JP) 2022-115421

(51) Int. Cl. A63F 13/44; A63F 13/48

(52) U.S. Cl. CPC A63F 13/44; A63F 13/48

(57) ABSTRACT

Disclosed herein is a server device including one or more processors having hardware. The one or more processors specify a status of a user and specify an activity to be recommended to the user, on the basis of the specified status of the user.

### CROSS REFERENCE TO RELATED APPLICATIONS

This application claims the benefit of Japanese Priority Patent Application JP 2022-115421 filed Jul. 20, 2022, the entire contents of which are incorporated herein by reference.

### BACKGROUND

The present disclosure relates to a technique for providing information relating to a game to a user.

Japanese Patent Laid-Open No. 2022-63756 discloses a server device that processes pieces of event data relating to an activity performed by a plurality of players. This server device obtains lengths of playing time for an activity performed by the plurality of players from a plurality of pieces of event data, sorting the players into any one of a plurality of classes according to a skill value of each player, to thereby determine a representative value of the playing time in each class, on the basis of the lengths of playing time of the plurality of players in each class. The server device notifies a user of the estimated playing time based on the representative value of the playing time associated with the class of the user.

### SUMMARY

Collecting pieces of data (play data) of a plurality of players having played a game by the server device makes it possible to derive various types of information through statistical processing or the like, thereby allowing the information to be provided to the user. In view of this, it is desirable to provide a technique for providing proper information to a user.

According to a mode of the present disclosure, there is a server device including a status specifying section configured to specify a status of a user and an activity specifying section configured to specify an activity to be recommended to the user, on the basis of the specified state of the user.

Another mode of the present disclosure is an information processing device operated by a user, including a transmission processing section configured to transmit information indicating a status of the user to a server device, an information obtaining section configured to obtain information regarding an activity recommended on the basis of the status of the user, and a display processing section configured to display the information regarding the activity.

A yet another mode of the present disclosure is an information providing method of providing information to a user, the method including specifying a status of a user, specifying an activity to be recommended to the user on the basis of the specified status of the user, and providing information regarding the specified activity to the user.

It is noted that any combinations of the constituent components described above and the expressions of the present disclosure that are converted between an method, a device, a system, a recording medium, a computer program, and the like are also effective as modes of the present disclosure.

### BRIEF DESCRIPTION OF THE DRAWINGS

FIG. 1 is a diagram illustrating an information processing system according to an embodiment of the present disclosure;

FIG. 2 is a block diagram illustrating a hardware configuration of an information processing device;

FIG. 3 is a block diagram illustrating functional blocks of the information processing device;

FIG. 4 is a block diagram illustrating functional blocks of a server device;

FIG. 5 is a diagram used for describing a calculation method for a length of playing time;

FIG. 6 is a diagram used for describing a deriving method for a play order;

FIG. 7 is a view illustrating an example of a system screen displayed on an output device; and

FIG. 8 is a view illustrating another example of the system screen displayed on the output device.

### DETAILED DESCRIPTION OF THE PREFERRED EMBODIMENT

In an embodiment of the present disclosure, an information processing device as a user terminal device executes game software. When an event occurs in a game, the game software outputs event information identifying the event having occurred to system software. An event occurs when there is a change in a progress of a game play or there is a change in an action by a game character, for example.

Game software includes a plurality of activities to each of which an end condition is set. Each activity may have a start condition set thereto, and in this case, a game progress performed from a timing at which the start condition is satisfied to a timing at which the end condition is satisfied constitutes one activity.

The activity is a play unit including a stage, a quest, a mission, a tournament, a session, and the like which are incorporated in the game. The activity is set by a game manufacturer as needed, and for example, one quest appearing in the progress of the game may include one activity, or a plurality of quests appearing as the game advances may include one activity. In a case in which a plurality of quests include one activity, completing all of the plurality of quests becomes the end condition of the activity.

Note that the game manufacturer may set all of the stage, the quest, the mission, the tournament, the session which are incorporated in the game as the activity. However, only some of the stage, the quest, the mission, the tournament, and the session may be set as the activity. As described above, a combination of a plurality of quests and a plurality of missions may be set as one activity, constituting one play unit.

When an activity is started, the game software outputs event information including an activity identifier (activity ID) identifying the activity and information indicating the start of the activity, to the system software. When the activity is ended, the game software outputs event information including the activity ID and information indicating the end of the activity, to the system software. The system software generates event data obtained by adding a user identifier (user account) which identifies the user, a game identifier (game ID) which identifies the game, and time information (a time stamp) to the event information output from the game software, and transmits the generated event data to an external server device.

The server device collects pieces of event data transmitted from a plurality of information processing devices operated by a plurality of players and analyzes play trends relating to an activity. For example, the server device may derive, through statistical processing, lengths of playing time of the plurality of players for the activity, on the basis of the pieces of event data transmitted from the plurality of information processing devices. In addition, the server device may derive, through statistical processing, an order in which a plurality of activities are to be performed in one game, on the basis of the pieces of event data transmitted from the plurality of information processing devices. Moreover, the server device may derive an activity which is most frequently played immediately after the start of the game play in one game, on the basis of the pieces of event data transmitted from one or more of the plurality of information processing devices.

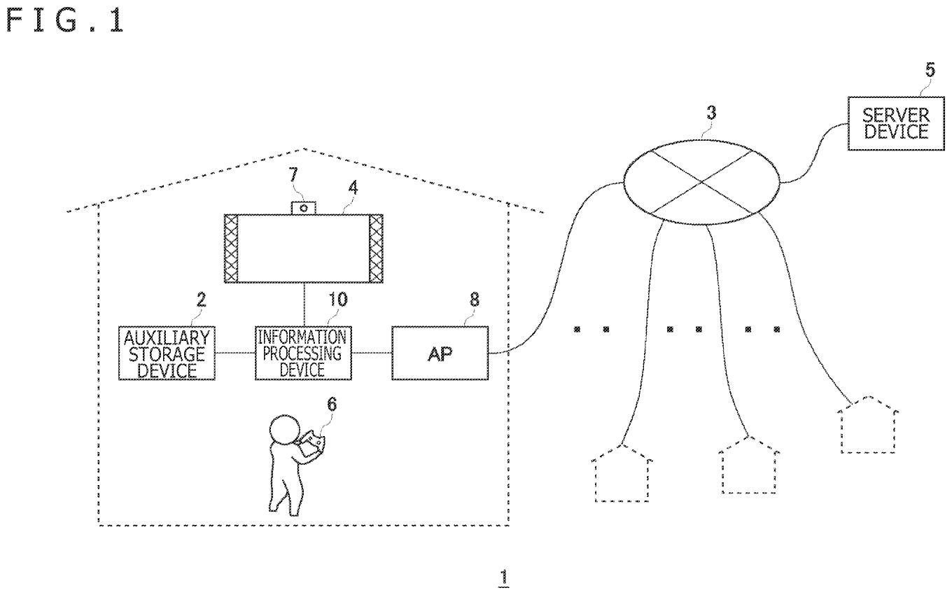

FIG. 1 illustrates an information processing system 1 according to the embodiment of the present disclosure. The information processing system 1 of the embodiment is a game system which supports a game play of a user (hereinafter, also referred to as a “player”), and includes an information processing device 10 that is operated by a user and a server device 5. An access point (hereinafter, referred to as an “AP”) 8 has a function of a wireless access point or a router, and the information processing device 10 is connected through the AP 8 to the server device 5 on the network 3 in a wireless or a wired manner so as to be able to communicate with the server device 5. FIG. 1 illustrates one user and one information processing device 10. However, the information processing system 1 illustrated in FIG. 1 is configured based on a premise that a plurality of information processing devices 10 which are operated by a plurality of users and the server device 5 are connected to each other through the network 3.

The information processing device 10 is connected to an input device 6 operated by a user in a wireless or a wired manner. The input device 6 outputs operation information indicating a result of operation by the user to the information processing device 10. When receiving the operation information from the input device 6, the information processing device 10 reflects the operation information in processing of system software or game software, and causes an output device 4 to output a result of the processing. In the information processing system 1, the information processing device 10 may be a game device (game console) that executes a game. The input device 6 may be a device such as a game controller which supplies the operation information of the user to the information processing device 10. Note that the input device 6 may be an input interface such as a keyboard or a mouse.

An auxiliary storage device 2 is a large capacity storage device such as a hard disk drive (HDD) or a solid state drive (SSD). The auxiliary storage device 2 may be a built-in type storage device or may be an external storage device connected to the information processing device 10 by a universal serial bus (USB) or the like. The output device 4 may be a television set including a display which outputs an image and a speaker which outputs sound. The output device 4 may be connected to the information processing device 10 via a cable or wirelessly.

A camera 7 functioning as an imaging device is provided in the vicinity of the output device 4 to capture an image of a space around the output device 4. In FIG. 1, the camera 7 is attached to an upper portion of the output device 4 as an example. However, the camera 7 may be disposed on a side portion or a lower portion of the output device 4. In either case, the camera 7 may be disposed at a position at which to be able to capture an image of the user located in front of the output device 4. The camera 7 may be a stereo camera.

The server device 5 provides the user of the information processing system 1 with a network service. The server device 5 manages a network account (user account) by which each user is identified, and each user signs in to the network service provided by the server device 5, with use of the user's network account. The user signs in to the network service from the information processing device 10 so as to be able to register save data on a game or a trophy that is a virtual reward obtained during a game play, in the server device 5. The server device 5 has the save data and the trophy registered therein, so that the user can synchronize the save data and the trophy, even when the user uses another information processing device that is different from the information processing device 10.

The server device 5 of the embodiment collects the pieces of event data from the plurality of information processing devices 10. The server device 5 processes pieces of information relating to each activity from the pieces of collected event data and, for example, derives an average length of playing time for each activity and an order in which the activities are to be played in a game through statistical processing. The server device 5 derives the order in which the activities are to be performed, in advance, so that, when the user has completed a certain activity, an activity that will highly possibly be carried out next can be specified, thereby making it possible to recommend the user for the relevant activity.

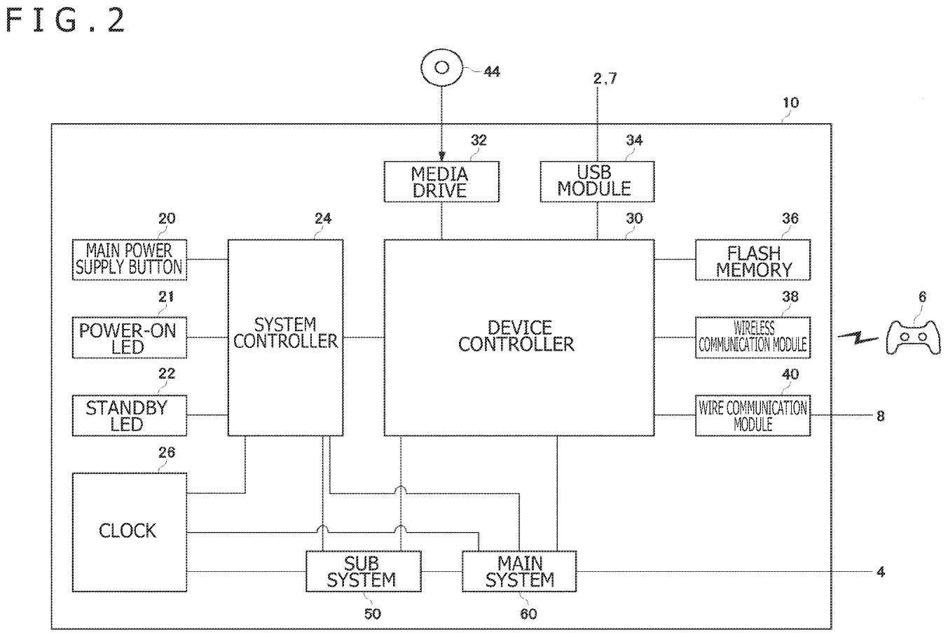

FIG. 2 illustrates a hardware configuration of the information processing device 10. The information processing device 10 includes a main power supply button 20, a power-on light-emitting diode (LED) 21, a standby LED 22, a system controller 24, a clock 26, a device controller 30, a media drive 32, a USB module 34, a flash memory 36, a wireless communication module 38, a wire communication module 40, a sub system 50, and a main system 60.

The main system 60 includes a main central processing unit (CPU), a memory as a main storage device, a memory controller, a graphics processing unit (GPU), and the like. The GPU is used mainly for computing processing of a game program. The main CPU has a function of activating the system software and executing the game program installed in the auxiliary storage device 2 under an environment provided by the system software. The sub system 50 includes a sub CPU, a memory as a main storage device, a memory controller, and the like. The sub system 50 does not include a GPU.

The main CPU has a function of executing the game program installed in the auxiliary storage device 2, whereas the sub CPU does not have such a function. However, the sub CPU has a function of accessing the auxiliary storage device 2 and a function of sending and receiving data to and from the server device 5. The sub CPU has such a limited processing function only, and can thus be operated with power consumption lower than the power consumption in operation of the main CPU. These functions of the sub CPU are executed when the main CPU is in a standby state.

The main power supply button 20 is an input section by which operating input from the user is performed. The main power supply button 20 is provided to a front surface of a casing of the information processing device 10. The main power supply button 20 is operated to turn on or off the supply of power to the main system 60 of the information processing device 10. The power-on LED 21 is lit when the main power supply button 20 is turned on. The standby LED 22 is lit when the main power supply button 20 is turned off. The system controller 24 detects pressing down of the main power supply button 20 by the user.

The clock 26 is a real-time clock. The clock 26 generates the current date and time information and supplies the generated date and time information to the system controller 24, the sub system 50, and the main system 60.

The device controller 30 is configured as a large-scale integrated circuit (LSI) which executes delivery of information between devices like a south bridge. As illustrated in FIG. 2, such devices as the system controller 24, the media drive 32, the USB module 34, the flash memory 36, the wireless communication module 38, the wire communication module 40, the sub system 50, and the main system 60 are connected to the device controller 30. The device controller 30 absorbs differences between electrical characteristics of the respective devices and differences between data transfer rates, and controls data transfer timing.

The media drive 32 is a drive device that is loaded with a read only memory (ROM) medium 44 on which such application software as a game and license information are recorded, that drives the ROM medium 44 to read a program, data, and the like from the ROM medium 44. The ROM medium 44 is a read-only recording medium such as an optical disc, a magneto-optical disc, or a Blu-ray disc.

The USB module 34 is a module connected to an external device by a USB cable. The USB module 34 may be connected to the auxiliary storage device 2 and the camera 7 by a USB cable. The flash memory 36 is an auxiliary storage device forming an internal storage. The wireless communication module 38 performs wireless communication with the input device 6, for example, using a communication protocol such as a Bluetooth (registered trademark) protocol or Institute of Electrical and Electronic Engineers (IEEE) 802.11 protocol. The wire communication module 40 performs wire communication with an external device and is connected to the network 3 via the AP 8.

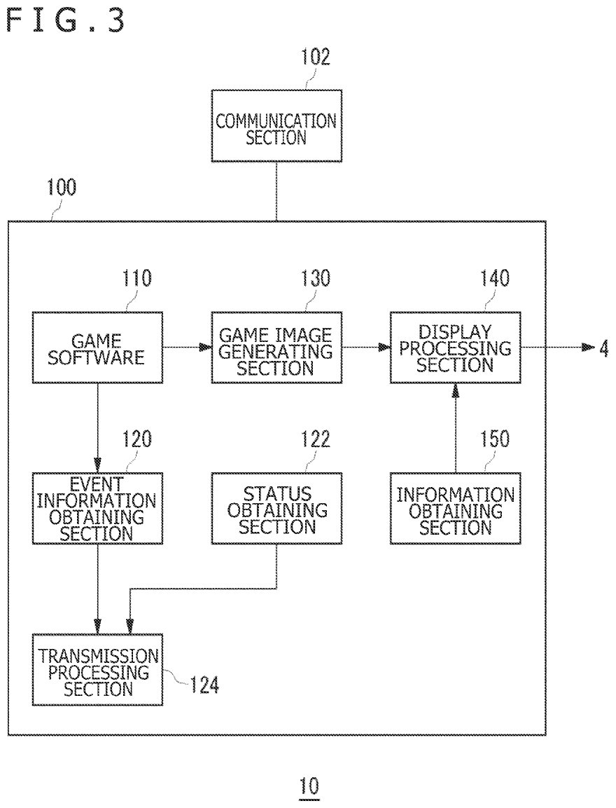

FIG. 3 illustrates functional blocks of the information processing device 10. The information processing device 10 includes a processing section 100 and a communication section 102. The processing section 100 includes a game software 110, an event information obtaining section 120, a status obtaining section 122, a transmission processing section 124, a game image generating section 130, a display processing section 140, and an information obtaining section 150.

The information processing device 10 includes a computer, and the computer executes a program, thereby achieving various functions indicated in FIG. 3. The computer has a memory in which a program is loaded, one or more processors that execute the loaded program, an auxiliary storage device, another LSI, and the like as hardware. The processor includes a plurality of electronic circuits including semiconductor integrated circuits and LSIs, and the plurality of electronic circuits may be mounted on a single chip or a plurality of chips. The functional blocks indicated in FIG. 3 are implemented in cooperation with hardware and software. Thus, it will be understood by those skilled in the art that these functional blocks may be variously implemented by hardware only, by software only, or by a combination of hardware and software.

The game software 110 includes at least a game program, image data, and sound data. The game program receives operation information on the input device 6 by the user, and executes computing processing for moving a game character in a virtual space. The game image generating section 130 includes a GPU which executes rendering processing and the like, and generates a game image on a game. A display processing section 140 outputs the generated game image from the output device 4. Note that the processing section 100 includes a game sound generation section which generates game sound data and a sound output section which outputs game sound. However, illustration of them is omitted in FIG. 3.

When an event has occurred during the progress of the game, the game program outputs event information indicating the occurrence of the event. Upon obtaining the event information from the game software 110, the event information obtaining section 120 generates event data by adding the user account, the game ID, and time information (a time stamp) indicating the time of the occurrence of the event to the event information, and provides the generated event data to the transmission processing section 124. Note that the game program may output the event information including the game ID and/or the time stamp to the event information obtaining section 120. The transmission processing section 124 transmits the generated event data to the server device 5 through the communication section 102.

In the game program, a start and an end of an activity are coded as an event. When the activity is started during the progress of the game, the game program outputs event information indicating occurrence of a starting event of the activity. When the activity is ended, the game program outputs event information indicating occurrence of an ending event of the activity. The game manufacturer may prepare various kinds of events in the game. For example, in a case in which a battle activity involving an enemy boss is incorporated in the game, the game program outputs event information indicating an activity ID identifying the battle activity and information indicating a start of the battle activity, when the battle is started. When the player wins in the battle against the enemy boss, the game program outputs event information including the activity ID identifying the battle activity, information indicating an end of the battle activity, and information indicating a success of the activity.

The transmission processing section 124 transmits event data relating to the activity performed by the player through the communication section 102 to the server device 5. In the information processing system 1, a process of transmitting event data is executed by all of the information processing devices 10 that are connected to the server device 5, and the server device collects, from the plurality of information processing devices 10, pieces of event data relating to various kinds of activities included in various kinds of games. Note that the transmission processing section 124 transmits not only event data relating to the activity, but also event data having no relation to the activity, to the server device 5. Preferably, when the event information obtaining section 120 obtains the event information from the game software 110, the event information obtaining section 120 immediately generates event data having a time stamp added thereto, and the transmission processing section 124 transmits the event data to the server device

The status obtaining section 122 obtains information indicating the context of the user, that is, information regarding the current status of the user. For example, the context of the user includes at least the statuses such as logging in to the information processing device 10, activating the game software 110 to start game play, and terminating execution of the game software 110 to end the game play. The status obtaining section 122 obtains, from the system software, information indicating that the user has logged in to the information processing device 10, information indicating that the game software 110 has been activated, and information indicating that the game software 110 has been terminated, as information indicating the current status (context) of the user. The status obtaining section 122 generates user status data to which the user account and time (a time stamp) at which the information is obtained are added to the information indicating the status of the user, to provide the generated user status data to the transmission processing section 124. The transmission processing section 124 transmits the generated user status data to the server device 5 though the communication section 102.

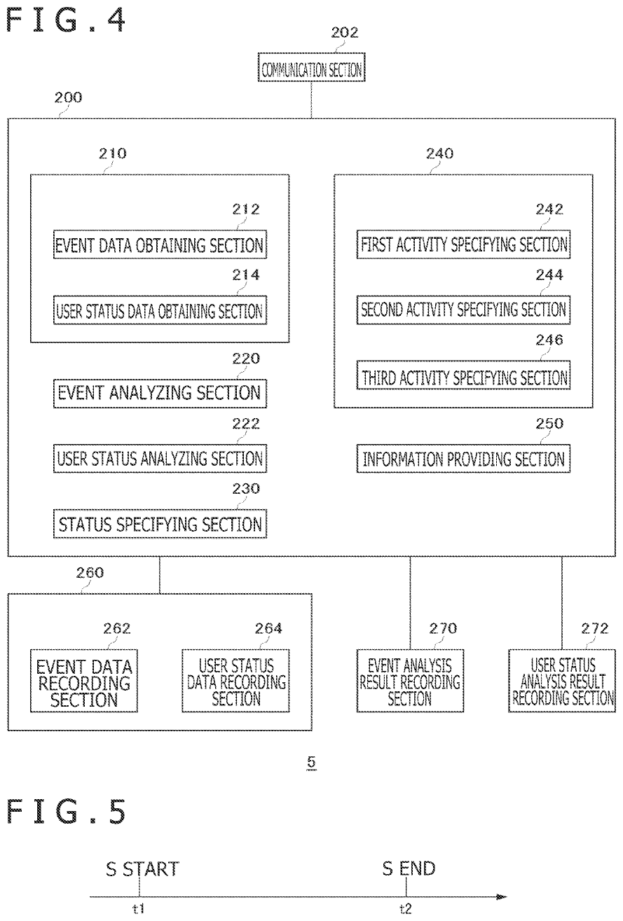

FIG. 4 illustrates functional blocks of the server device 5 in the embodiment. The server device 5 includes a processing section 200, a communication section 202, a data recording section 260, an event analysis result recording section 270, and a user status analysis result recording section 272. The processing section 200 includes a data obtaining section 210, an event analyzing section 220, a user status analyzing section 222, a status specifying section 230, an activity specifying section 240, and an information providing section 250. The data obtaining section 210 has an event data obtaining section 212 and a use status data obtaining section 214. The activity specifying section 240 has a first activity specifying section 242, a second activity specifying section 244, and a third activity specifying section 246. The data recording section 260 has an event data recording section 262 and a user status data recording section 264.

The server device 5 includes a computer, and the computer executes a program, thereby achieving various functions indicated in FIG. 4. The computer has a memory in which a program is loaded, one or more processors that execute the loaded program, an auxiliary storage device, another LSI, and the like as hardware. The processor includes a plurality of electronic circuits including semiconductor integrated circuits and LSIs, and the plurality of electronic circuits may be mounted on a single chip or a plurality of chips. The functional blocks indicated in FIG. 4 are implemented in cooperation with hardware and software. Thus, it will be understood by those skilled in the art that these functional blocks may be variously implemented by hardware only, by software only, or by a combination of hardware and software.

The data obtaining section 210 obtains pieces of data from the plurality of information processing devices 10 and records the obtained data in the data recording section 260.

The event data obtaining section 212 obtains pieces of event data relating to the activity performed by the plurality of players, from the plurality of information processing devices 10, and records the pieces of event data in the event data recording section 262. The event data recording section 262 records the pieces of event data in association with the network account of each player, for each game title. As described above, the event data includes at least the game ID, the activity ID, the information indicating the start and end of the activity, and the time stamp. Note that the event data obtaining section 212 may obtain the event data having no relation to the activity and record the event data in the event data recording section 262.

The event analyzing section 220 analyzes pieces of event data relating to an activity having been performed by a plurality of players and obtains information indicating a play history relating to the activity. The event analyzing section 220 in the embodiment analyzes pieces of past event data on a game X having been performed by the plurality of players, to thereby derive an average length of playing time for each of a plurality of activities and a play order of the plurality of activities.

### (Deriving of Average Length of Playing Time for Activity)

The event analyzing section 220 obtains playing time for the activity for each player. The event analyzing section 220 obtains the lengths of playing time of the plurality of players for the activity, from the pieces of event data (start event data) including activity start event information and event data (end event data) including activity end event information, which are recorded in the event data recording section 262. Playing time for an activity is calculated on the basis of a time stamp included in the start event data and a time stamp included in the end event data.

FIG. 5 is a diagram used for describing a calculation method for playing time. FIG. 5 indicates a start event and an end event of an activity S performed by a single player when the single player plays the activity S. Specifically, “S START” represents the start event of the activity S, and “S END” represents the end event of the activity S. The start event data includes a start time t1 of the activity S, while the end event data includes an end time t2 of the activity S. The event analyzing section 220 calculates the length of playing time of the player for the activity S to be (t2-t1). The event analyzing section 220 records the calculated length of playing time for the activity S in the event analysis result recording section 270, in association with the network account of the player, along with the game ID and the activity ID. Similarly, the event analyzing section 220 calculates the lengths of playing time of the other players for the activity S and records the calculated lengths of playing time of the other players for the activity S in the event analysis result recording section 270, in association with the network account of the other players, along with the game ID and the activity ID.

The event analyzing section 220 performs averaging processing on the derived lengths of playing time of all of the players for the activity S of the game X and derives an average length of playing time for the activity S. The event analyzing section 220 records the derived average length of playing time for the activity S of the game X in the event analysis result recording section 270.

In this manner, the event analyzing section 220 also derives average lengths of playing time for other activities and records the average lengths of playing time for all of the activities in the game X in the event analysis result recording section 270.

### (Extraction of Relation Regarding Play Order of Activity)

In a case in which the game X is a story-based game and a game in which an order of activities to be played is relatively likely to be determined (for example, an adventure game), the event analyzing section 220 specifies the play order of the plurality of activities in the game X.

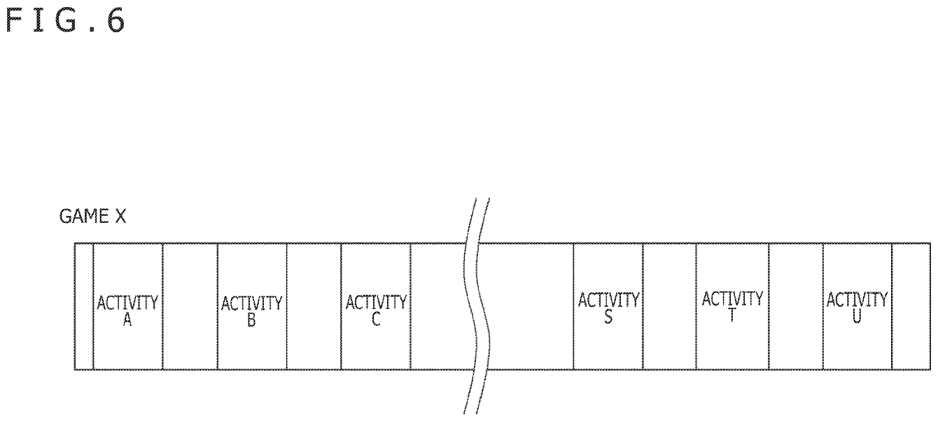

FIG. 6 is a diagram used for describing a deriving method for a play order. FIG. 6 indicates a playing situation from a timing at which a single player starts to play the game X to a timing at which to complete the game X. Specifically, in this playing situation, there is indicated a play order in which the player has completed from the first stage to the final stage of the game X.

The event analyzing section 220 refers to the pieces of event data recorded in the event data recording section 262 to derive play orders of the activities performed by all of the plurality of players who have completed the game X. The event analyzing section 220 may perform statistical processing on all of the derived play orders and extract relations regarding the play orders of the activities. For example, the event analyzing section 220 recognizes that, when a ratio at which a player who played the activity B will play the activity C next is 80% or higher in the game X, a tendency that the activity C is to be played next after the activity B is strong. Also, the event analyzing section 220 recognizes that, when a ratio at which a player who played the activity C will play the activity D next is 80% or higher in the game X, a tendency that the activity D is to be played next after the activity C is strong. Hence, the event analyzing section 220 extracts relations regarding the play orders of the activities to record the extracted relations in the event analysis result recording section 270.

### (Specification of Activity to be Played First in Game Play of One Day)

The event analyzing section 220 refers to the pieces of event date recorded in the event data recording section 262 to specify an activity that is often played by a player at a time of start of game play of a day. For example, in the case of the game X based on a story, the player advances the game along the story. Accordingly, the event analyzing section 220 refers to the relations regarding the play orders of the activities recorded in the event analysis result recording section 270 and may specify an activity that is played at the time of start of game play of a day as an activity which is more likely to be played next after an activity having been played just before the end of the previous game play. In this case, the event analyzing section 220 determines that the activity to be played first in game play of a day is an activity which follows the relations regarding the play orders of the activities, to record the determination as the analysis result in the event analysis result recording section 270.

The event analyzing section 220 performs statistical processing on the pieces of event data of the plurality of players and may specify an activity which is often played by the plurality of players at the time of start of game play of a day. Alternatively, the event analyzing section 220 refers to the pieces of event data for each player, and may specify an activity which is often played at the time of start of game play of a day, for each player.

In addition, regarding a sports game Y, the event analyzing section 220 refers to the pieces of event data recorded in the event data recording section 262 to specify an activity that is often played by a player at a time of start of game play of a day. For example, the event analyzing section 220 may specify that the activity which is often played by a player at the time of start of game play of a day is an activity for developing a player, in the sports game Y. The event analyzing section 220 determines, in the game Y, that the activity which is often played by a player at the time of start of game play of a day is as a player development activity and then records the determination as the analysis result in the event analysis result recording section 270. The event analyzing section 220 may specify the activity which is often played by the plurality of players at the start of game play of a day by performing statistical processing on the pieces of event data of the plurality of players. However, the event analyzing section 220 may alternatively refer to the pieces of event data for each player and may specify the activity which is often played by a player at the time of start of game play of a day, for each player.

The event analyzing section 220 may periodically perform the above analysis with use of the pieces of event data. For example, it is preferable that the event analyzing section 220 perform the above analysis as frequently as, for example, once a day or once a week, to record the latest analysis result in the event analysis result recording section 270.

The user status data obtaining section 214 obtains pieces of user status data from the plurality of players from the plurality of information processing devices 10 to record the obtained data in the user status data recording section 264. The event data recording section 262 records the user status data in association with the network account of each player. As described above, the user status data includes information indicating the status of the user and time (a time stamp) at which the relevant information is obtained. The information indicating the states of the user may include the information indicating that the user has logged in, the information indicating that the game software 110 has been activated, and the information indicating that the game software 110 has been ended.

The user status analyzing section 222 analyzes the pieces of user status data for past multiple days accumulated in the user status data recording section 264 to specify a play schedule in a day of each user. Specifically, the user status analyzing section 222 derives a login timing of the user from the information indicating that the user has logged in, derives a play start timing of a game from the information indicating that the game software has been activated, and derives a play end timing of the game from the information indicating that the game software has been ended. The user status analyzing section 222 may derive a login timing, a play start timing, and a play end timing of each user by day of a week or by weekdays or holidays. The user status analyzing section 222 derives the play schedule of each user to record the derived schedule in the user status analysis result recording section 272. In the embodiment, the play end timing in the play schedule is used to estimate a timing at which the user ends the play.

Hereinafter, an example of a play schedule on Sunday which is derived for a user A is indicated.
Login timing: 13:50
Play start timing: 14:00
Play end timing: 20:00

This play schedule is derived from the pieces of user status data for multiple days from among the past Sundays and does not guarantee that the user A acts according to this schedule every Sunday. However, the status specifying section 230 in the embodiment may use this play schedule to predict the action of the user A on Sunday. The status specifying section 230 specifies the current status of the user at a play start timing or a play end timing of the game on the basis of the user status.

### (Upon Login by User)

When the user A logs in to the information processing device 10 one Sunday, the status obtaining section 122 obtains the information indicating that the user A has logs in to the information processing device 10, from the system software. The transmission processing section 124 transmits the user status data obtained by adding the account of the user A and time (a time stamp) at which the user A has logged therein to the information indicating that the user A has logs therein, through the communication section 102 to the server device 5.

In the server device 5, the user status data obtaining section 214 obtains the user status data, and the status specifying section 230 specifies the status of the user A, from the user status data. Specifically, the status specifying section 230 decides, from the relevant user status data, that the user A has logged in to the information processing device 10 and has not yet started game play, specifying that the user A is about to play the game play from now.

The activity specifying section 240 includes a function of specifying an activity to be recommended to the user, on the basis of the status of the user specified by the status specifying section 230. Specifically, the activity specifying section 240 specifies an activity to be recommended to the user, on the basis of a selection criterion corresponding to the status of the user. The selection criterion may be set for each type of game, and for example, the selection criterion to be set may be different between a story-based game and a sports game, for example. Note that the selection criterion may be set for each game title.

The first activity specifying section 242 specifies an activity to be recommended to the user on the basis of a first selection criterion corresponding to a status in which the user is about to play game play from now. When the status specifying section 230 decides that the user has not yet started game play and specifies that the user is about to start game play from now, the first activity specifying section 242 specifies an activity to be recommended to the user, on the basis of the first selection criterion. Here, the first selection criterion corresponds to the analysis result specified as an activity which is often played at the time of start of game play of a day by the event analyzing section 220.

The first activity specifying section 242 refers to the relations regarding the play orders of the activities in accordance with the first selection criterion for the story-based game X, to specify the activity that is more likely to be played next after the activity having been played just before the end of the previous game play of the game X. In a case in which the event analysis result recording section 270 records that the ratio at which the player who played the activity B will play the activity C next is 80% or higher as the relations regarding the play orders of the activities, the first activity specifying section 242 specifies the activity C as an activity to be recommended to the user, if the activity having been played just before the end of the previous game play of the game X is the activity B. In the case of the story-based game X, the user A expects the game progress along the story, and therefore, recommending the activity C matches the user's wish.

Also, the first activity specifying section 242 specifies the player development activity in accordance with the first selection criterion for the sports game Y. The event analysis result recording section 270 records that the activity which is often played in the game Y at the beginning of the day is the player development activity, and hence, the first activity specifying section 242 specifies the player development activity in the game Y as the activity to be recommended to the user.

The information providing section 250 transmits the information regarding the activity to be recommended to the user A at the time of start of game play to the information processing device 10 of the user A who has not yet started the game play, through the communication section 202. In the information processing device 10, the information obtaining section 150 obtains the information regarding the recommended activity, from the server device 5. The display processing section 140 displays the information obtained by the information obtaining section 150.

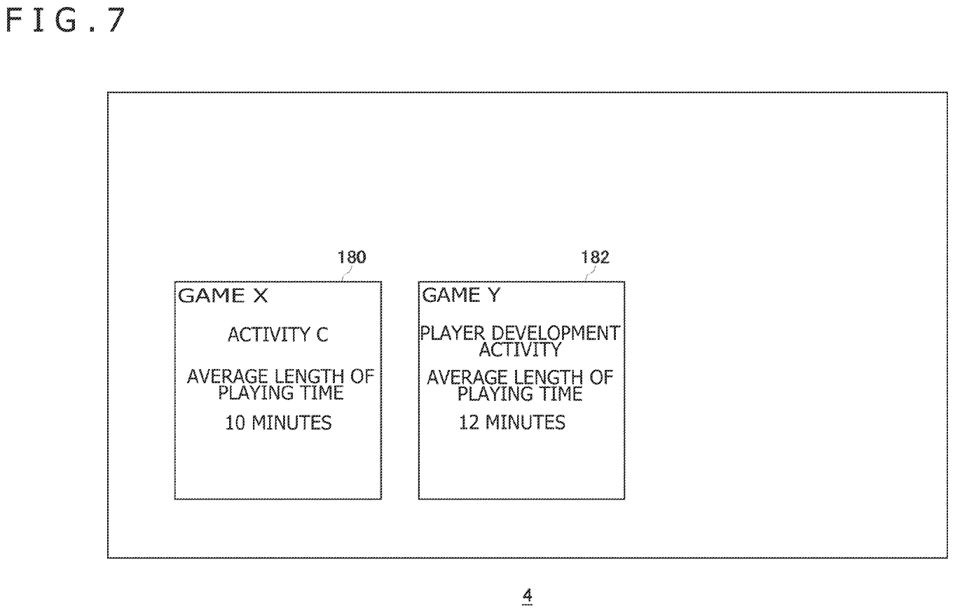

FIG. 7 illustrates an example of a system screen displayed on the output device 4 before the start of the game. The display processing section 140 generates system images 180 and 182 from the information obtained by the information obtaining section 150 to display the generated images on the output device 4. On the system image 180, the activity name of the game X “ACTIVITY C” and the average length of playing time “10 MINUTES” are displayed, and on the system image 182, the activity name of the game Y “PLAYER DEVELOPMENT ACTIVITY” and the average length of playing time “12 MINUTES” are displayed. The system images 180 and 182 displayed in a form of a card may be a graphical user interface (GUI), and when the user selects the system image 180, the game X is automatically activated, and the activity C corresponding to the relevant system image 180 may automatically be started. Similarly, when the user selects the system image 182, the game Y is automatically activated, and the player development activity corresponding to the relevant system image 182 may automatically be started.

### (During Play of User)

When the user A who has logged in to the information processing device 10 activates the game software 110, the status obtaining section 122 obtains the information indicating that the game software 110 is activated, from the system software. The transmission processing section 124 transmits the user status data obtained by adding the account of the user A and time (a time stamp) at which the user A activates the game software 110 to the information indicating that the game software 110 is activated, to the server device 5 through the communication section 102.

In the server device 5, the user status data obtaining section 214 obtains the user status data, and the status specifying section 230 specifies the status of the user from the user status data. Specifically, the status specifying section 230 decides, from the user status data, that the user has started game play and specifies that the user is playing the game.

The second activity specifying section 244 specifies the activity to be recommended to the user on the basis of a second selection criterion corresponding to the statue in which the user is plying the game. When the status specifying section 230 decides that the user has started game play and specifies that the user is playing the game, the second activity specifying section 244 specifies the activity to be recommended to the user on the basis of the second selection criterion. Here, the second selection criterion is set so as to preferentially select the activity having a relatively long average length of playing time.

It is not preferable to recommend the activity having a long average length of playing time to the user at a timing at which the user is about to end the game. In view of this, at a timing at which the user has not ended the game yet, according to the second selection criterion, it is preferable to select the activity having a relatively long average length of playing time in the game. For example, as the relations regarding the play orders of the activities regarding the game X, the event analysis result recording section 270 records that the ratios at which the player who played the activity D will play the activity E and the activity F next are each 40%. In a case in which the average length of playing time for the activity E is longer than that for the activity F, the second activity specifying section 244 specifies the activity having a longer average length of playing time as the activity E to be recommended to the player who played the activity D in the game X.

Similarly, the second activity specifying section 244 may preferentially specify the activity having a longer average length of playing time as the activity to be recommended to the user, in accordance with the second selection criterion for the sports game Y.

The information providing section 250 transmits the information regarding the activity to be recommended during the game play to the information processing device 10 of the user A who is playing the game, through the communication section 202. In the information processing device 10, the information obtaining section 150 obtains the information regarding the activity to be recommended from the server device 5. The display processing section 140 displays the information obtained by the information obtaining section 150.

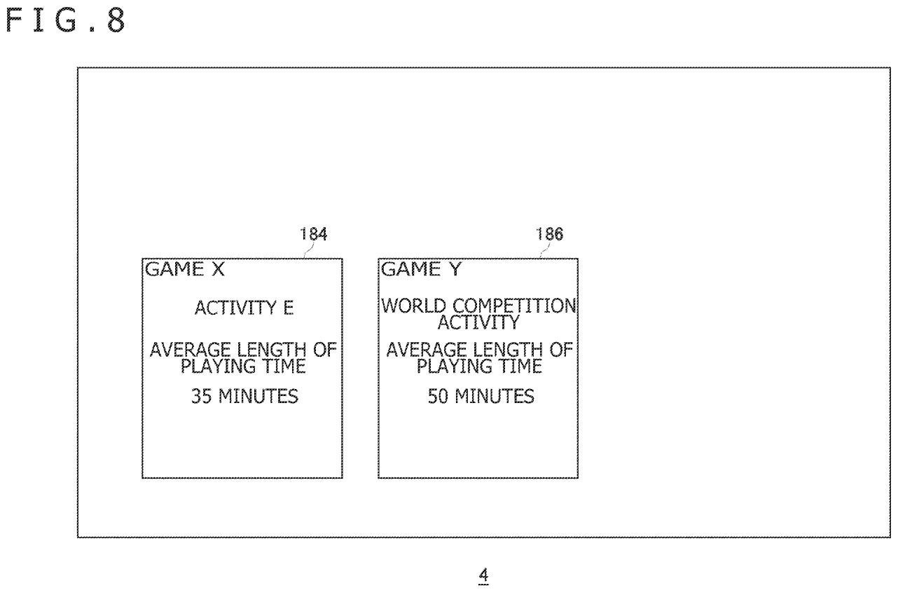

FIG. 8 illustrates an example of a system screen displayed on the output device 4. The display processing section 140 generates the system images 184 and 186 according to the information obtained by the information obtaining section 150, to display the generated system images on the output device 4. On the system image 184, the activity name of the game X “ACTIVITY E” and the average length of playing time “35 MINUTES” are displayed, and on the system image 186, the activity name of the game Y “WORLD COMPETITION ACTIVITY” and the average length of playing time “50 MINUTES” are displayed. The system images 184 and 186 displayed in a form of a card may be a GUI.

### (Just Before User Ends Game Play)

The user status analysis result recording section 272 records the play schedule of the user A on Sunday as below.
Login timing: 13:50
Play start timing: 14:00
Play end timing: 20:00

The status specifying section 230 estimates a timing at which the user ends game play according to the play schedule, and specifies that the user is about to end the game play from an estimated play end timing. Specifically, the status specifying section 230 specifies that the user is about to end the game play, if the current time is near the play end timing (20:00).

The third activity specifying section 246 specifies the activity to be recommended to the user on the basis of the third selection criterion corresponding to the status in which the user is about to end the game play. When the status specifying section 230 decides that the current time is near the play end timing and specifies that the user is about to end the game play, the third activity specifying section 246 specifies the activity to be recommended to the user on the basis of the third selection criterion. Here, the third selection criterion is set so as to preferentially select the activity having a relatively short average length of playing time.

The third activity specifying section 246 specifies the activity having a short average length of playing time as the activity to be recommended to the user on the basis of the third selection criterion, regardless of the type of game. The information providing section 250 transmits the information regarding the activity to be recommended just before the end of the game play to the information processing device 10 of the user A through the communication section 202. In the information processing device 10, the information obtaining section 150 obtains the information regarding the recommended activity from the server device 5. The display processing section 140 displays the information obtained by the information obtaining section 150.

The present disclosure has been described above on the basis of the embodiment thereof. The foregoing embodiment is illustrative, and it is to be understood by those skilled in the art that combinations of constituent elements and processing processes of the embodiment are susceptible of various modifications and that such modifications also fall within the scope of the present disclosure. In the embodiment, the information processing device 10 is a home game console and may alternatively be a cloud server which provides a cloud gaming service to the user A.

What is claimed is:

1. A server device comprising:
one or more processors having hardware,
wherein the one or more processors
specify a status of a user, and
specify an activity to be recommended to the user, on a basis of the specified status of the user.

2. The server device according to claim 1, wherein the one or more processors specify the current status of the user with respect to a play start timing or a play end timing of a game.

3. The server device according to claim 2, wherein the one or more processors
decide that the user has not yet started the game, and
specify that the user is about to start game play from now.

4. The server device according to claim 2, wherein the one or more processors
estimate a timing at which the user ends game play, and
specify that the user is about to end the game play, according to the estimated play end timing.

5. The server device according to claim 1, wherein the one or more processors specify an activity to be recommended to the user, on a basis of a selection criterion corresponding to the status of the user.

6. The server device according to claim 5, wherein the selection criterion is set for each game.

7. An information processing device operated by a user, comprising:
one or more processors having hardware,
wherein the one or more processors
transmit information indicating a status of the user to a server device,
obtain information regarding an activity recommended on a basis of the status of the user, and
display the information regarding the activity.

8. An information providing method of providing information to a user, the method comprising:
specifying a status of a user;
specifying an activity to be recommended to the user, on a basis of the specified status of the user; and
providing information regarding the specified activity to the user.
